(19) United States
(12) Patent Application Publication
(10) Pub. No.: US 2009/0072525 A1
(43) Pub. Date: Mar. 19, 2009

(54) Stabilizer pad for vehicles

(75) Inventor: Robert S. Banks, Cannon Falls, MN (US)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: Strike Tool, Inc., Cannon Falls, MN (US)

(21) Appl. No.: 11/855,250

(22) Filed: Sep. 14, 2007

(51) Int. Cl. B60S 9/02

(52) U.S. Cl. 280/763.1; 248/188.8

(57) ABSTRACT

A pad for positioning between a surface and an outrigger plate of the vehicle. The pad includes a polymeric shell and a foam core is contained within the polymeric shell to provide a lightweight pad which is able to withstand the forces provided when securing a vehicle in a raised position.

### FIELD OF THE INVENTION

The present invention relates to a stabilizer pad for securing a vehicle in an elevated position. More particularly, the present invention relates to a stabilizer pad that is positioned between a surface and an outrigger that is attached to the vehicle, where the outrigger exerts a force on the stabilizer pad to lift the vehicle's wheels above the surface.

### BACKGROUND OF THE INVENTION

Many motorized vehicles that are utilized in the construction industry, whether to lift objects or to perform excavation, require a stable base from which a construction activity is performed. The vehicles typically have wheels to easily and quickly move the vehicle to a construction site and to different locations at the construction site. However, when forces are exerted upon the vehicle due to the construction activity, the wheels have a tendency to roll, which creates an unstable base from which the vehicle operates.

Outriggers are utilized to provide a stable base for the vehicle to perform the construction activity. Each outrigger includes a hydraulic ram spaced from the wheels of the vehicle to provide a wider base which increases stability. The ram usually includes a plate attached to a moving end of the ram that presses down upon the surface which in turn elevates the wheels of the vehicle above the surface to thereby provide the stable base. However, the outrigger plates generally do not have an adequate surface area to both support the vehicle when the vehicle is raised and also prevent damage to the surface, especially when the surface is compressible, such as asphalt, tar, a moist soil or gravel. If the surface is soft, the outrigger plates have a tendency of pressing into the surface which creates an indentation that damages the surface.

To prevent damage to the surface, pads are placed beneath the plates to spread out the force being delivered through the outrigger. The pads have a surface area that is larger than the outrigger plate to reduce the pressure exerted on the surface by the outrigger plate. Pads are constructed of various materials, some of which are common to the job site. For example, multiple layers of treated plywood are secured together, typically with nails or screws to form a pad on which the outrigger plate is placed. However, a plywood pad has disadvantages. Over time and due to wetness at the construction site, the layers of plywood tend to delaminate from each other and degrade. Further, the weight of the plywood pads make the plywood pads difficult to manually carry from one location to another.

Steel plates have also been utilized to decrease the pressure that the outrigger plate exerts upon the surface. Steel plates are also very heavy and difficult to maneuver and carry.

Aluminum plates are not as heavy as steel plates which makes the plates more easy to maneuver. However, aluminum plates are expensive due to the cost of aluminum and as a result have a tendency of being stolen from the construction site due to the scrap metal price for aluminum.

Solid plastic or polymer plates have also been developed. The solid plastic polymer plates are heavy and difficult to move from one location to another.

### SUMMARY OF THE INVENTION

The present invention includes a stabilizing pad having an outer shell that includes a substantially flat bottom layer and a substantially flat top layer that are substantially parallel to each other. The outer shell also includes a sidewall that connects the bottom and top layers such that the outer shell defines a cavity therein. A polymeric foam material is contained within the cavity. The stabilizing pad of the present invention is light-weight while providing adequate structural integrity to withstand the forces of an outrigger plate.

The present invention also includes a method of manufacturing a stabilizing pad. The method includes providing a mold and placing a selected amount of polymer material into the mold. The mold is heated and rotated to melt the polymeric material onto surfaces of the mold. The mold and the polymeric material are cooled to a solid state to form an outer shell defining a cavity. The outer shell is removed from the mold and a hole is created in the outer shell to provide access to the cavity. Polymeric foam is injected into a void created between the surfaces of the outer shell to form the stabilizing pad.

The present invention also includes a pad for positioning between a surface and an outrigger of a vehicle where the pad includes a water resistant shell and a foam core.

### BRIEF DESCRIPTION OF THE DRAWINGS

FIG. 1 is a perspective view of the present invention positioned between a surface and an outrigger plate.

FIG. 2 is a sectional view of the stabilizing pad of the present invention.

FIG. 3 is a perspective view of the pads of the present invention.

FIG. 4 is a sectional view of multiple stabilizing pads of the present invention stacked one on top of the other.

FIG. 5 is a bottom view of a stabilizing pad of the present invention.

### DETAILED DESCRIPTION OF ILLUSTRATIVE EMBODIMENTS

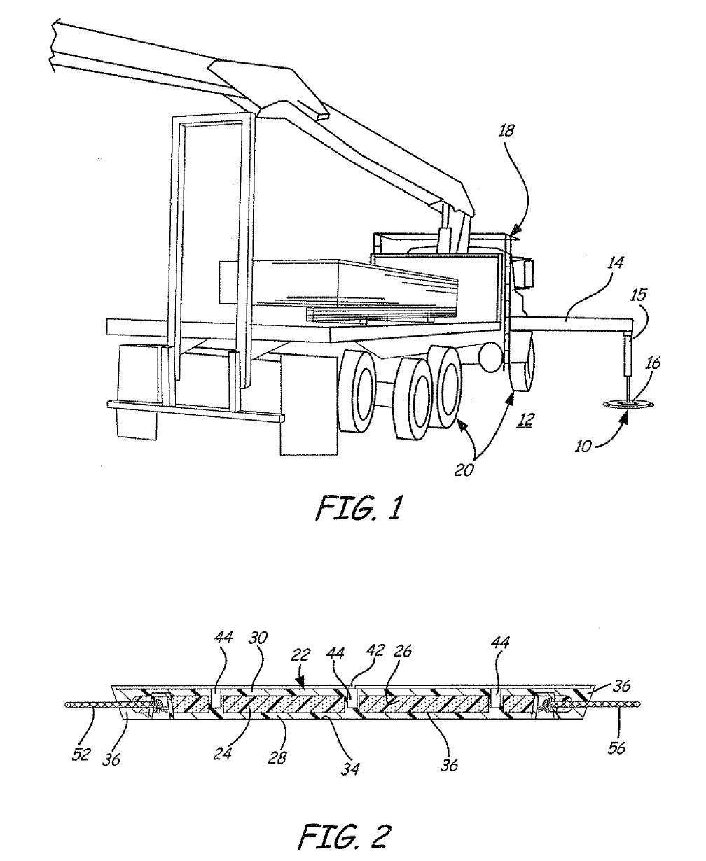

A stabilizing pad of the present invention is generally indicated in FIG. 1 at 10. The stabilizing pad 10 is positionable between a surface 12 and a plate 16 attached to a ram 15 of an outrigger 14 where the outrigger 14 is attached to and extends from a vehicle 18.

While only one outrigger 14 is illustrated, typically, three or more outriggers 14 are attached to the vehicle to elevate wheels 20 of the vehicle 18 above the surface 12 to provide a stable base from which construction activities can be performed. Each outrigger 14 typically includes the hydraulically powered ram 15 that is extended to elevate the wheels 20 of the vehicle 18 above the surface 12 by placing a force on the pad 10 and the surface 12.

The pad 10 has a surface area that contacts the surface 12 that is greater than a surface area of the outrigger plate 16 such that the pressure exerted on the surface 12 is less than the amount of pressure that is applied by the outrigger plate 16 by itself. The pad 10 prevents the surface 12, such as an asphalt or tar surface, compressible soil or gravel, from being damaged by forcing the outrigger plate 16 into the surface 12 which creates an indentation in the surface 12.

The pad 10 is constructed of a plastic or polymer outer shell 22 and a foam core 24 as illustrated in FIG. 2. The pad 10 has the strength to withstand up to at least 2,500 pounds of force while being about half the weight of a typical solid polymeric stabilizing pad.

The outer shell 22 is typically constructed of a high-density polyethylene. The high-density polyethylene outer shell 22 does not corrode, does not rust and is moisture resistant, and therefore, is well suited for use at a construction site where corrosive materials and moisture may be present, depending upon the ambient conditions. Other moisture resistant materials such as polypropylene and other olefin polymers, polyesters and nylons for constructing the outer shell 22 are also contemplated.

The outer shell 22 is preferably formed by rotational molding providing a mold having a cavity in the shape of the outer shell 22. A selected amount of the high-density polyethylene resin particles are placed within the mold. The mold is sealed to retain the resin therein. The mold is heated and rotated resulting in centrifugal forces that cause the high-density polyethylene resin particles to the heated mold's surfaces which then melt the resin particles to form the outer shell 22. After a selected amount of time, the mold and high-density polyethylene are allowed to cool and thereby solidifying the high-density polyethylene outer shell 22. The mold is then removed from the outer shell 22 prior to injecting the foam core 24 into a cavity 26 within the outer shell 22.

The outer shell 22 includes a substantially flat bottom layer 28 and a substantially flat top layer 30 that have outer surfaces substantially parallel to each other. The bottom layer 28 and the top layer 30 are connected by a continuous sidewall 36 that typically has a circular perimeter. Both the top layer 30 and bottom layer 28 typically have textured outer surfaces 32, 34 that increase the ability of the outrigger plate 16 to grip the surface 12 as illustrated in FIG. 1, and thereby increasing the stability of the vehicle 18 when the wheels 20 are elevated above the surface 12.

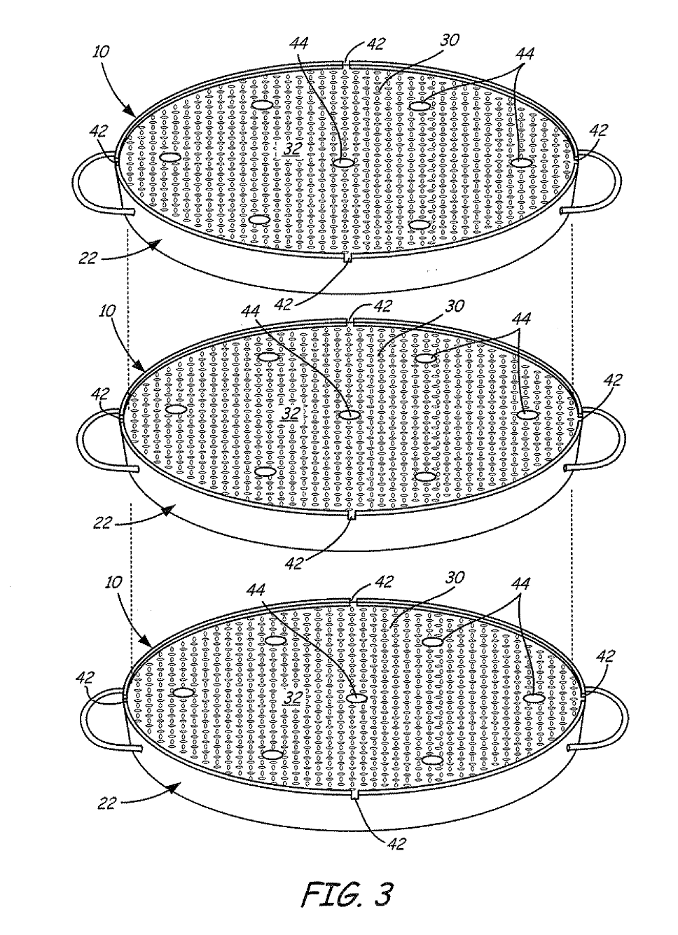

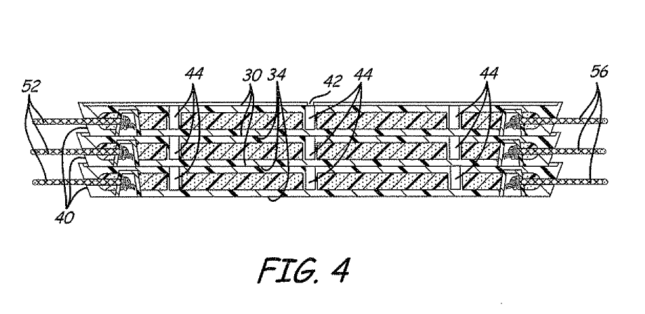

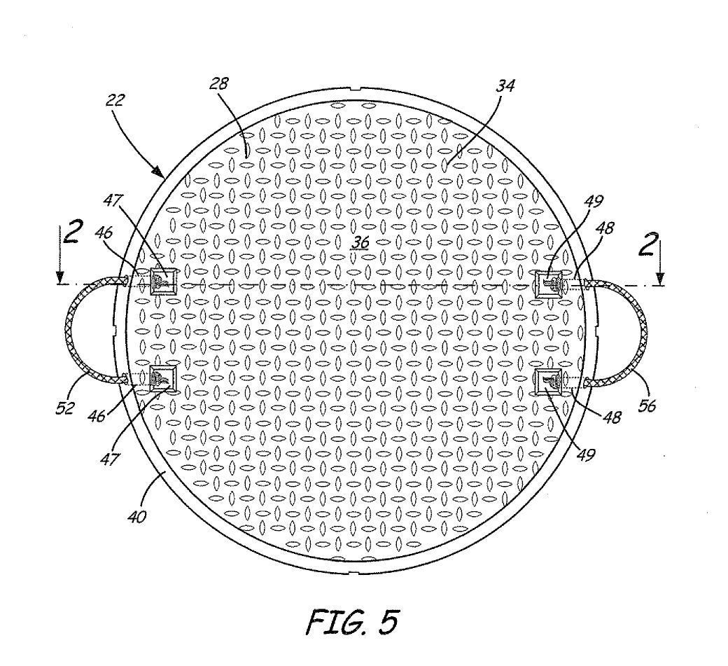

The top layer 30 is typically between about ⅜ of an inch and about 1½ inches wider in diameter than the bottom layer 28 such that the outer surface of the sidewall 36 is slanted outwardly from the bottom layer 28 to the top layer 30. With the bottom layer 28 having a smaller diameter than the diameter of the top layer 30, the pads are stackable (nestable) one on top of the other, as best illustrated in FIGS. 3 and 4.

The outer shell 22 includes a rim 38 extending upwardly from around a perimeter 40 of the top plate 30 above the top surface of layer 30 to aid in stacking the pads. The rim 38 also provides a barrier to prevent the outrigger plate 16 from slipping off the textured surface 32 of the top layer 30. The diameter of the bottom layer is sufficiently smaller so that when stacked the rim and the bottom layer do not interfere with the nesting feature of this invention

The rim 40 is interrupted typically by four evenly placed troughs 42 in the rim 40 to allow water to run off the top surface 32 of the top layer 30. While four evenly spaced troughs 42 are typical, a rim 40 with no troughs 42 or one or more troughs 42 is also contemplated.

The top layer 30 and the bottom layer 28 are connected to each other by connections 44 that are formed in-situ as the shell 22 is formed. The purpose of the connections 44 is to prevent the upper and lower layers from bulging during the foaming process. The number and positioning of the connections 44 will vary depending on the pressure of the foam being applied within the shell 22 and the surface area and thickness of the upper and lower layers and the polymer from which the shell is made. There may be also other factors that need to be considered. In any event, a sufficient number of connections are needed to prevent the upper and lower layers from bulging or bowing outwardly. In the example illustrated in the drawings, the connections 44 are in the form of cylindrical wells having an opening at the top layer 30 and which extend down to the bottom layer 28. The bottom of the well ends are part of the bottom layer 28 such that wells do not provide passage through the bottom layer. In the embodiment illustrated in the FIGS. 2-4, there are seven wells with one being positioned in the center of the shell 22 while six others are disposed in a circular pattern, each well in the circular pattern positioned approximately 80% of the distance from the center to the perimeter of the shell.

In one instance, the center well may be drilled out through the bottom layer so that the pad may be hung on a hook or nail. The drilling will not affect the integrity of the pad.

A pair of rope handles 52 and 56 are provided to aid in carrying the pad 10. The rope handles 52 and 56 are attached to the shell 22 through a set of bores 46 and 48, respectively, that are molded within the shell and whose inner ends terminate within pockets 47 and 49, respectively. The pockets 47 and 49 extend from the interior ends of bores 47 and 48 to the exterior surface of the layer 28. The ends of each rope handle 52 and 56 are inserted into the bores 46 and 48 and then through the pockets 47 and 49 at which the ends are tied into knots. The knots are larger than the diameter of the bores 46 and 48 thereby retaining the rope handles in place within the bones 44 and 48. The rope handles are made with a stiff enough material such that the rope handles extend directly outwardly from the sidewall.

Since the rope handles 52, 56 extend directly from the sidewall and therefore minimize the accidental positioning of the outrigger plate 16 on a rope handle. In addition, when the pad 10 is placed on the surface 12, the rope handles 52, 56 are positioned above the ground surface 12, and therefore typically do not get as dirty or wet as a handle attached to a bottom surface of a pad. The rope handles also do not interfere in stacking the pads 10 as illustrated in FIG. 4 due to their attachment at the sidewall.

A hole is typically drilled into the shell 22 to provide access to the cavity 26 for injecting the foam 24 therein. The walls of the outer shell 22 are typically about 1/32 to ¼ of an inch thick while the thickness of the pad is typically between about 2 inches and 3 inches which provides a cavity 26 therebetween. The foam material 24 is injected into the cavity 26 that is disposed between the top and bottom layers 30, 28 such that the foam fills the entire cavity 26.

The foam material 24 is typically a polymeric material such as polyurethane. The foam material 24 typically has a density of greater than 7 pounds per cubic foot. Typically, the foam material 24 has a density of between about 8 pounds per cubic foot and 20 pounds per square cubic foot and more typically about 16 pounds per cubic foot. While a polyurethane foam is typical, other foam materials are also within the scope of the present invention.

As the foam material 24 is forced into the cavity 26, pressure is created between the top and bottom plates 30, 28, respectively. The connections 44 provide sufficient rigidity to withstand the pressure and forces created during the foaming process and prevents the top and bottom layers from bowing outwardly.

The surfaces 32, 34 of the top and bottom layers 28 and 30, respectively, typically are textured to provide a roughened surface which increases the traction on both the bottom layer 28 and the top layer 30. The pattern is typically a diamond shaped pattern which extends into the surfaces 32, 34 of the top and bottom layers 30, 28, respectively. Typically, the diamond pattern extends into the layers 30, 28 and not away from the layers 30, 28 to prevent indentations from being forced into the surface 12 such as when the surface is a soft asphalt. Other patterns that roughen the surface 32, 34 are also contemplated.

The pads 10 are typically circular in configuration and typically come in nominal 24 inch, 30 inch and 36 inch diameters. The thickness of the pad 10 including the rim 40 is typically about 3 inches with the rim 40 being typically about ½ inch above the surface of the top layer. A pad 10 with a 24 inch nominal diameter weighs about 20 pounds and a pad 10 with a 36 inch nominal diameter has a weight of approximately 40-45 pounds when filled with a 16 pound per cubic foot density foam. Each of the pads 10 is constructed to withstand over 2,500 pounds of force, which is typically required to retain a large construction truck or crane in an elevated position.

While a circular pad 10 is typical to allow the pad to be either carried or rolled to a selected position, other configurations of the pad 10 such as square or octangular are also within the scope of the present invention. Further, other dimensions of the pads 10 are also within the scope of the present invention besides the dimensions provided herein.

Although the present invention has been described with reference to preferred embodiments, workers skilled in the art will recognize that changes may be made in form and detail without departing from the spirit and scope of the invention.

What is claimed is:

1. A stabilizing pad comprising:
an outer shell comprising spaced apart and substantially flat and parallel bottom and top layers and a sidewall connecting the bottom and top layers and wherein the bottom layer, top plate and sidewall define a cavity therein; and
a polymeric foam material within the cavity.

2. The stabilizing pad of claim 1 and wherein the sidewall has a substantially circular perimeter.

3. The stabilizing pad of claim 1 and wherein the outer shell comprises a polymeric resin.

4. The stabilizing pad of claim 1 and wherein the shell comprises a rim extending upwardly from a perimeter of the top layer.

5. The stabilizing pad of claim 4 and wherein the rim includes at least one trough for allowing water to drain from the top layer.

6. The stabilizing pad of claim 1 and wherein the sidewall slants outwardly from a perimeter of the bottom layer to a perimeter of the top layer such that the stabilizing pads are stackable one on top of another.

7. The stabilizing pad of claim 1 and wherein outer surfaces of the bottom layer and the top layer have inwardly extending designs.

8. The stabilizing pad of claim 1 and further including at least one handle extending from the sidewall.

9. The stabilizing pad of claim 1 and wherein the polymeric foam material comprises a foam density greater than about 8 pounds per cubic foot.

10. The stabilizing pad of claim 1 and wherein the polymeric foam material comprises a foam density between about 8 pounds per cubic foot and about 20 pounds per cubic foot.

11. The stabilizing pad of claim 1 and wherein the bottom and top layers are connected by at least one connection extending through the cavity.

12. A method of manufacturing a stabilizing pad comprising:
providing a mold;
placing a selected amount of polymeric resin in the mold;
rotating and heating the mold to melt the polymeric resin onto surfaces of the mold;
cooling the mold and the polymeric material to a solid state to form a outer shell comprising a bottom layer, a top layer and a sidewall connecting the top layer and the bottom layer, wherein the outer shell defines a cavity;
removing the outer shell from the mold;
creating a hole in the outer shell; and
injecting a polymeric foam into the cavity to form the stabilizing plate.

13. The method of claim 12 and wherein the polymeric resin comprises a high-density polyethylene.

14. The method of claim 12 and further comprising providing the mold with inserts to mold connections between the bottom layer and the top layer.

15. The method of claim 12 and wherein the polymeric foam has a density of between about 8 pounds per cubic foot and 20 pounds per cubic foot.

16. The method of claim 12 and further comprising:
forming at least one set of channels into the sidewall of the outer shell; and
inserting a handle into the at least one set of channels.

17. A pad for positioning between a surface and an outrigger plate of a vehicle, the pad comprising a water resistant shell and a foam core having a density greater than 8 pounds per cubic foot.

18. The pad of claim 17 wherein the shell comprises spaced apart and substantially flat and substantially parallel bottom and top layers and a sidewall connecting the bottom and top layers and wherein the bottom layer, the top layer and the sidewall define a cavity therein and wherein the foam core substantially fills the cavity.

19. The pad of claim 18 and wherein the shell comprises a rim extending upwardly from about a perimeter of the top layer.

20. The plate of claim 19 and wherein the rim includes at least one trough for allowing water to drain from the top layer.

21. The pad of claim 17 and wherein the shell comprises a polymeric resin.

22. The pad of claim 18 and wherein the sidewall slants outwardly from a perimeter of the bottom layer to a perimeter of the top layer such that the pads are stackable one on top of another.

23. The pad of claim 18 and wherein the top layer and the bottom layer both include inwardly extending designs that provide gripping surfaces.

24. The pad of claim 18 and further comprising at least one handle extending from sidewall.

25. The pad of claim 17 and wherein the foam core comprises a density between about 8 pounds per cubic foot and about 20 pounds per cubic foot.
